(19) United States
(12) Patent Application Publication
(10) Pub. No.: US 2007/0012248 A1
(43) Pub. Date: Jan. 18, 2007

(54) Apparatus to clean infant's pacifier anywhere

(76) Inventor: Karen Helene Aucoin, Lancaster, MA (US)

Correspondence Address: Karen H. Aucoin, 1444 North Main Street, Lancaster, MA, 01523, US

(21) Appl. No.: 11/182,448

(22) Filed: Jul. 16, 2005

(51) Int. Cl. B05C 11/00

(52) U.S. Cl. 118/270

(57) ABSTRACT

An apparatus to clean infant's pacifier anywhere with A small, clear, plastic container with a cleaning solution soaked sponge for storing pacifier when not in use, A sponge with a convex shape to conform to concave shape of pacifier mouthpiece for cleaning, A sponge with a crosscut center which allows nipple to be cleaned as it is inserted and removed, A cap that compresses the pacifier into the sponge to insure all surfaces make contact for cleaning, An attatched optional compartment to store additional or sanitized pacifier, and A small clip to allow Binky-Bath to be attached to diaper bag for easy reach. All parts of Binky-Bath are easily disassembled for easy cleaning. Replacement sponges can be purchased. Binky-Bath comes in attractive designs and themes for boys, girls and both sexes.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of child hygiene and more specifically to an apparatus to clean infant's pacifier anywhere.

Every mother of a child who uses a pacifier has at one time been faced with the dilema of what to do when the child's pacifier has been dropped on the floor. Having to choose between giving the child the soiled pacifier back, put the pacifier in your own mouth to remove unknown contamination, or just let the child cry as you put it away until it could be cleaned did not allow for any happy answer.

There is a product available for cleaning a pacifiers that consists of a pump spray bottle and a shield to hold the pacifer against. The pacifier is cleaned as it is sprayed. While the current technology is portable, it is not compact enough to be carried in the pocket of a diaper bag, purse, etc. Also, it would not be as convenient to have to remove the shield section, spray bottle, etc and begin the cleaning process in the middle of a depatment store, restaurant, etc as the child cries, as it would be to simply reach into the bag, open Binky Bath and hand child a clean pacifier, or insert the pacifier into Binky Bath and remove it, ready to give a clean pacifier back to the child in seconds.

### BRIEF SUMMARY OF THE INVENTION

The primary object of the invention is have the ability to give your child a clean pacifier without worrying about contamination while away from home.

Another object of the invention is no more mothers having to suck off unknown dirt, germs, etc. before giving pacifier back to baby when it has been dropped.

Another object of the invention is that it eliminates need to carry multiple pacifiers in the event one is dropped or another child has put the pacifier in their mouth.

A further object of the invention is the ability to store pacifier in a germ free enviroment between use.

Yet another object of the invention is no more need to ask store employee, waitress, etc. for water source to rinse off a dropped pacifier while child screams.

Still yet another object of the invention is that it is small enough to be easily stored in pocket of diaper bag, purse, glove compartment, etc.

Another object of the invention is it's universal size to fit all brand pacifiers.

Another object of the invention is that it is a completely portable,compact, and convenient method of always having a clean pacifier on hand.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to clean infant's pacifier anywhere comprising: a small, clear, plastic container with a cleaning solution soaked sponge for storing pacifier when not in use, a sponge with a convex shape to conform to concave shape of pacifier mouthpiece for cleaning, a sponge with a crosscut center which allows nipple to be cleaned as it is inserted and removed, a cap that compresses the pacifier into the sponge to insure all surfaces make contact for cleaning, An attatched optional compartment to store additional or sanitized pacifier, and a small clip to allow Binky-Bath to be attached to diaper bag for easy reach.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a exploded view of Binky Bath cleaning aparatus.

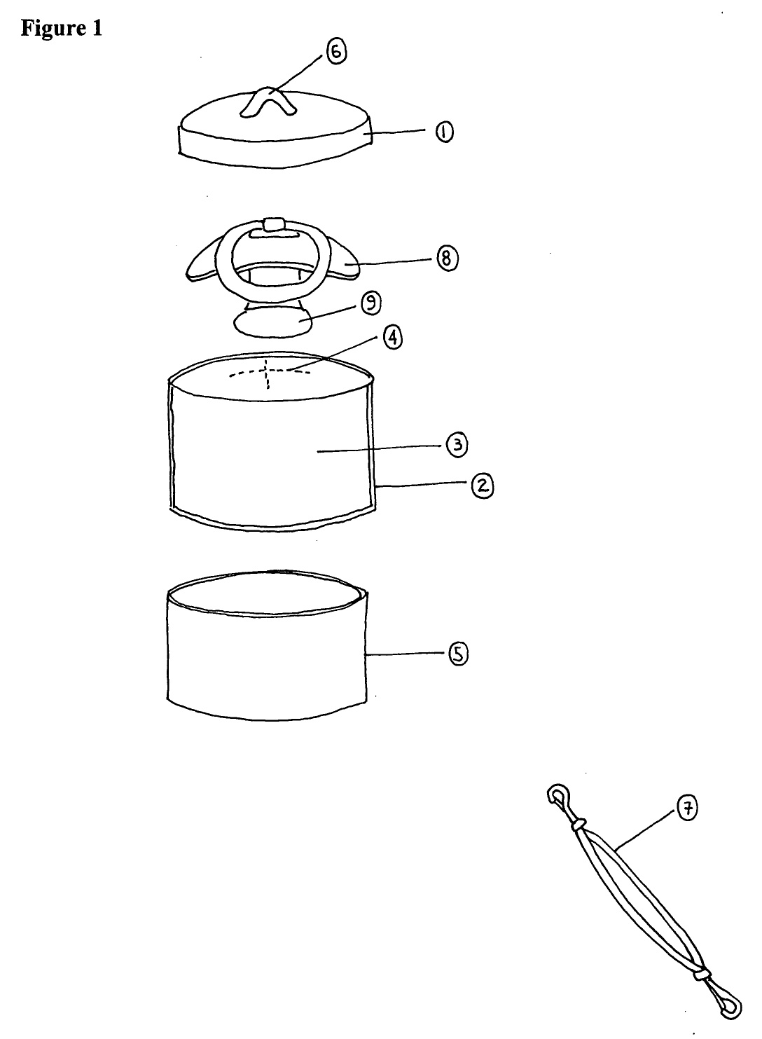

FIG. 2 is a transparent elevational view of the invention with pacifier inserted.

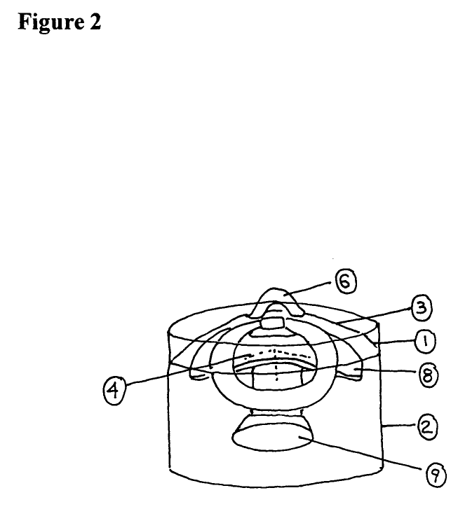

FIG. 3 is an elevational view of the invention showing sponge contour to pacifier mouthpeiece.

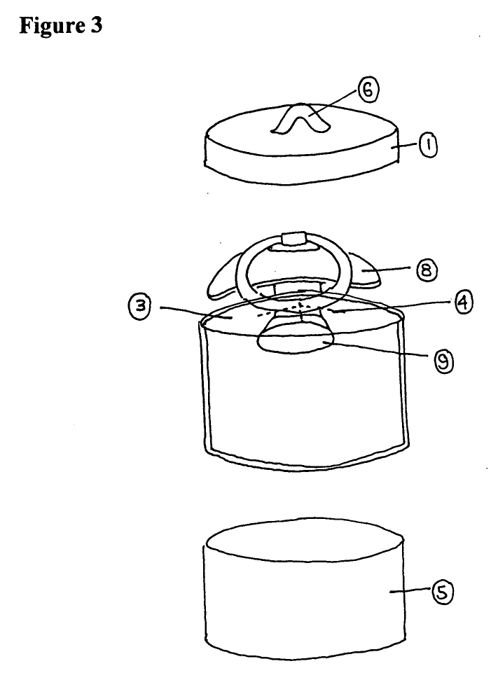

FIG. 4 is a plan view of the invention with cover removed.

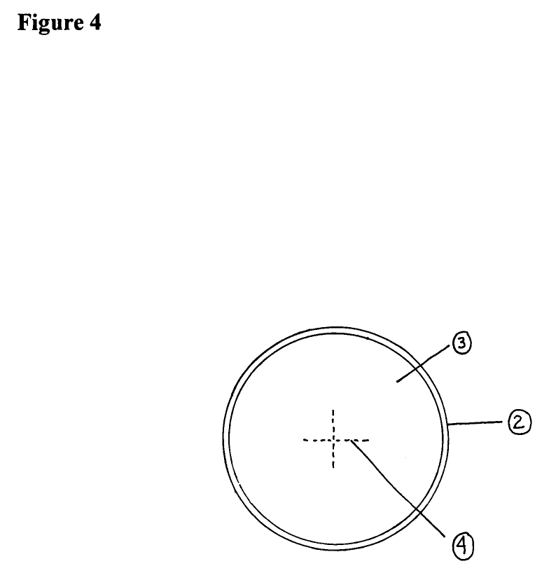

FIG. 5 is a plan view of the invention with cover removed and pacifier inserted.

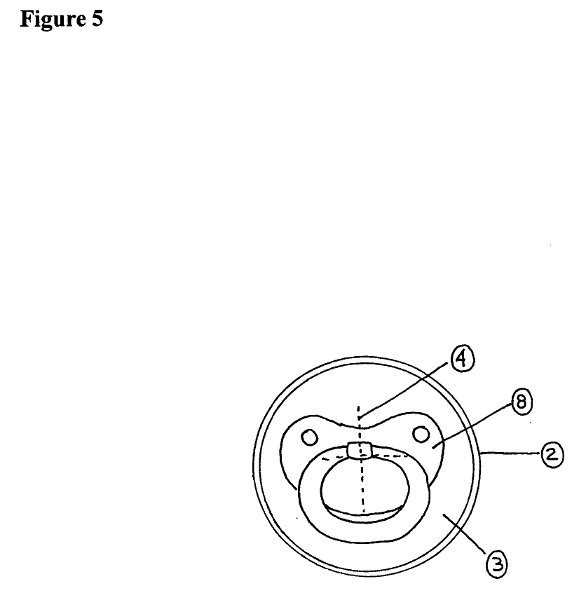

### Binky-Bath

1) Cover
2) Cleaning compartment
3) Convex shaped sponge
4) Crosscut
5) Storage compartment
6) Attachment clip loop
7) Attachment clip
8) Pacifier mouthpiece
9) Pacifier nipple

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Binky-Bath is a convenient and completely portable apparatus that allows a child to be given a clean pacifier anywhere, at any time, in any circumstance while away from home. Until now, when faced with the dilemma of a crying infant and dropped pacifier without an available water source , the only choice was to either put the pacifier in your own mouth to remove any unknown contamination, or return it to the child unclean. Binky-Bath consists of a small, plastic compartment (2) containing a fluid (either water or a cleaning solution) filled, convex shaped sponge (3) with a crosscut center (4). The pacifier nipple (9) is cleaned as it is inserted into the crosscut (4) and then removed, and the mouthpiece of the pacifier (8) is cleaned as the cap (1) is screwed on, compressing it into the convex shaped shaped sponge (3) insuring surface contact. The (optional) compartment ( 5) beneath allows an additional pacifier to be stored in a clean enviroment. A loop (6) on the cover allows Binky-Bath to be secured to a diaper bag, purse, etc., using the attachment clip (7) for easy reach when needed.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to clean infant's pacifier anywhere comprising:
A small, clear, plastic container with a cleaning solution soaked sponge for storing pacifier when not in use;
A sponge with a convex shape to conform to concave shape of pacifier mouthpiece for cleaning;
A sponge with a crosscut center which allows nipple to be cleaned as it is inserted and removed;
A cap that compresses the pacifier into the sponge to insure all surfaces make contact for cleaning;
An attatched optional compartment to store additional or sanitized pacifier; and
A small clip to allow Binky-Bath to be attached to diaper bag for easy reach.
